(19) United States
(12) Patent Application Publication
(10) Pub. No.: US 2021/0034364 A1
(43) Pub. Date: Feb. 4, 2021

(54) PROCESSING UNIT, PROCESSOR, PROCESSING SYSTEM, ELECTRONIC DEVICE AND PROCESSING METHOD

(71) Applicant: Alibaba Group Holding Limited, George Town (KY)

(72) Inventor: Yudong Li, Shanghai (CN)

(21) Appl. No.: 16/938,231

(22) Filed: Jul. 24, 2020

(30) Foreign Application Priority Data
Aug. 1, 2019 (CN) 201910705802.5

(51) Int. Cl. G06F 9/38; G06F 9/4401; G06F 13/28; G06F 13/36

(52) U.S. Cl. CPC G06F 9/3836; G06F 9/4418; G06F 13/36; G06F 13/28; G06F 9/3802

(57) ABSTRACT

The present application discloses a method, electronic device, processing unit, processing system, and system for processing operations. The method includes reading instruction information from an instruction tightly-coupled memory, reading data information from a data tightly-coupled memory, and executing one or more operations corresponding to one or more instructions, the one or more instructions being executed based at least in part on the instruction information and the data information.

### CROSS REFERENCE TO OTHER APPLICATIONS

This application claims priority to People's Republic of China Patent Application No. 201910705802.5 entitled PROCESSING UNIT, PROCESSOR, PROCESSING SYSTEM, ELECTRONIC DEVICE AND PROCESSING METHOD filed Aug. 1, 2019 which is incorporated herein by reference for all purposes.

### FIELD OF THE INVENTION

The present invention relates to a field of processor manufacturing. More specifically, the present application relates to a processing unit, a processor, a processing system, an electronic device, and a method for processing, and a method for manufacturing a processor.

### BACKGROUND OF THE INVENTION

At present, both X86 architecture processors and Advanced RISC Machines (ARM) architecture processors make use of a tiered storage structure. According to such architectures, multiple levels of memory are added between a processor core (CPU core) and a main memory. Access speed declines for each level of memory that a memory being accessed resides from the processor core. Multilevel memory can include tightly-coupled memory (TCM), L1 cache, and L2 cache. Tightly-coupled memory and L1 cache can be positioned nearest the processor core. L2 cache and other memory can be positioned at a short distance from the processor core. Various other compositions of multilevel memory can be implemented according to such architectures. For example, multilevel memory contains only one or the other of tightly-coupled memory and L1 cache.

According to such processor architectures, both tightly-coupled memory and caches are configured to increase processor execution efficiency. Specifically, data information and instruction information are stored in tightly-coupled memory or caches. The processor core can read data information and instruction information from the tightly-coupled memory or cache. However, because instruction information and data information are simultaneously placed in the tightly-coupled memory, the processor core cannot simultaneously fetch instruction information and data information in keeping with the instruction pipeline. Therefore, the instruction flow of the processor is ruined by the fetching of data, and the fetching of data causes invalid instructions to be provided to the processor. Accordingly, execution efficiency is negatively impacted by the fetching of instruction information and data information using processor architectures according to the related art.

### BRIEF DESCRIPTION OF THE DRAWINGS

Various embodiments of the invention are disclosed in the following detailed description and the accompanying drawings.

FIG. 1 is a diagram of a processing unit according to various embodiments of the present application.

FIG. 2 is a diagram of a processor core according to various embodiments of the present application.

FIG. 3 is a diagram of a processing system according to various embodiments of the present application.

FIG. 4A is a diagram of a processing system according to various embodiments of the present application.

FIG. 4B is a diagram of a processing system according to various embodiments of the present application.

FIG. 5 is a flowchart of a method for a processing system to execute instructions according to various embodiments of the present application.

FIG. 6 is a space-time diagram of an instruction pipeline used by a processing system according to various embodiments of the present application.

FIG. 7A is a diagram of instruction tightly-coupled memory storing instruction information for audio processing and wake-up processing according to various embodiments of the present application.

FIG. 7B is a diagram of data tightly-coupled memory storing data information relating to audio processing and wake-up processing according to various embodiments of the present application.

FIGS. 8A through 8D are diagrams of processing units implemented in an electronic device according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The present invention is described below on the basis of embodiments, but the present invention is not limited to these embodiments. In the following description of the details of the present invention, some specific details are described exhaustively. A person skilled in the art would be able to completely understand the present invention without the description of these details. To avoid confusing the substance of the present invention, there is no detailed recitation of well-known methods and processes. In addition, the drawings are not necessarily drawn according to proportion.

As used herein, an “electronic device” generally refers to a device comprising one or more processors. An electronic device can be a device used (e.g., by a user) within a network system and used to communicate with one or more servers. According to various embodiments of the present disclosure, an electronic device includes components that support communication functionality. For example, an electronic device can be a smart phone, a server, a machine of shared power banks, information centers (such as one or more services providing information such as traffic or weather, etc.), a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a kiosk such as a vending machine, a smart home appliance, vehicle-mounted mobile stations, or the like. An electronic device can run various operating systems.

As used herein, tightly-coupled memory (TCM) is a low-latency memory that the processor can use without the unpredictability that is a feature of caches. The size of a TCM is generally selected independent from a size of another TCM and is generally from 4 KB to 256 KB. Various other sizes of TCM can be implemented. According to various embodiments, a TCM has dedicated connection to the processor (e.g., processor core).

According to various embodiments, an instruction processor interprets and executes executable code according to instruction sets. The instruction sets are pre-stored. For example, the instruction sets can be stored in the instruction processor or another memory connected to, or otherwise accessible by, the instruction processor. Instruction information is used to indicate the specific operations specified by instructions. Data information is used to indicate operands corresponding to the specific operations (e.g., the specific operations identified in the instruction information). An execution of an instruction includes a corresponding operation being executed on corresponding operands. For example, execution of an instruction includes obtaining one or more operations from instruction information, obtaining one or more operands from corresponding data information, and performing the one or more operations based at least in part on the one or more operands. According to various embodiments, an instruction set generally includes three main types of instructions: a jump (e.g., jump instruction), an arithmetic operation (e.g., including such arithmetic operations as adding, subtracting, multiplying, and dividing), and a data access (e.g., reading data from memory and writing back data to memory). Various embodiments include other instructions and/or the execution of such other instructions. In some embodiments, in connection with execution of an instruction, flow control, mathematical operations, and data access, or any combination thereof, is implemented. A jump instruction can refer to instructing a processor to jump to a particular address. For example, the jump instruction specifies an offset from a current address from which a next instruction is to be fetched.

According to various embodiments, a TCM is partitioned into at least an instruction tightly-coupled memory and a data tightly-coupled memory. In response to partitioning the TCM, the instruction tightly-coupled memory is used in connection with storing instruction information and not data information, and the data tightly-coupled memory is used in connection with storing information and not instruction information. In connection with executing an operation, a processor core reads instruction information from the instruction tightly-coupled memory, and reads data information from the data tightly-coupled memory. In some embodiments, the TCM that is partitioned into at least an instruction tightly-coupled memory and a data tightly-coupled memory is a conventional processing unit (e.g., a processing unit with a TCM such as a processing unit with a single TCM).

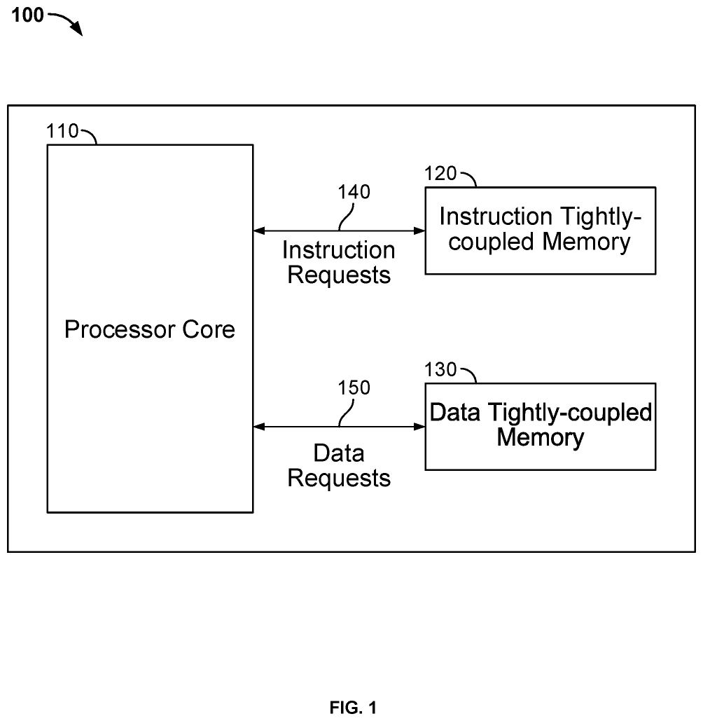

FIG. 1 is a diagram of a processing unit according to various embodiments of the present application.

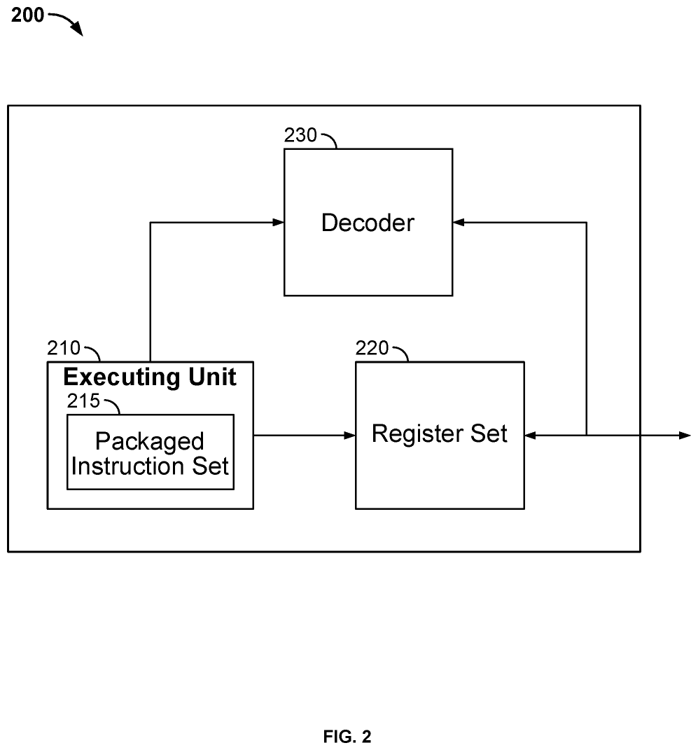

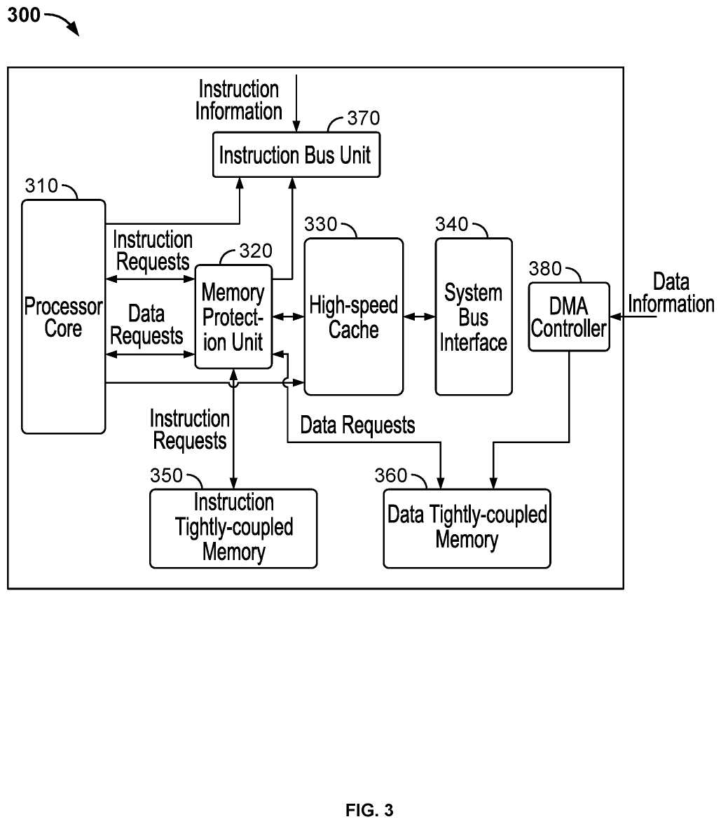

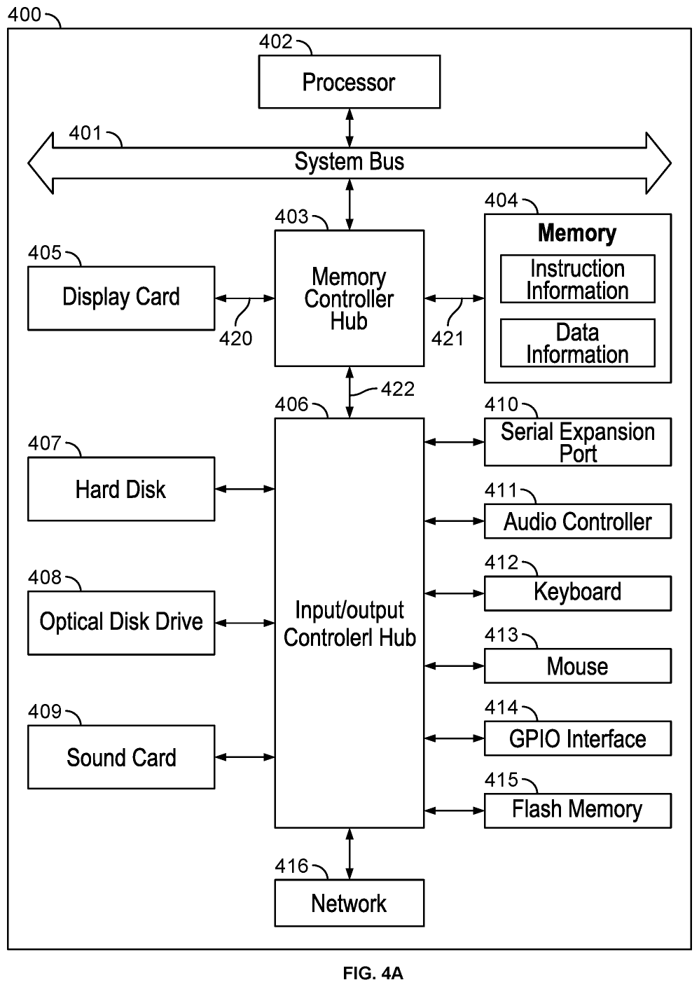

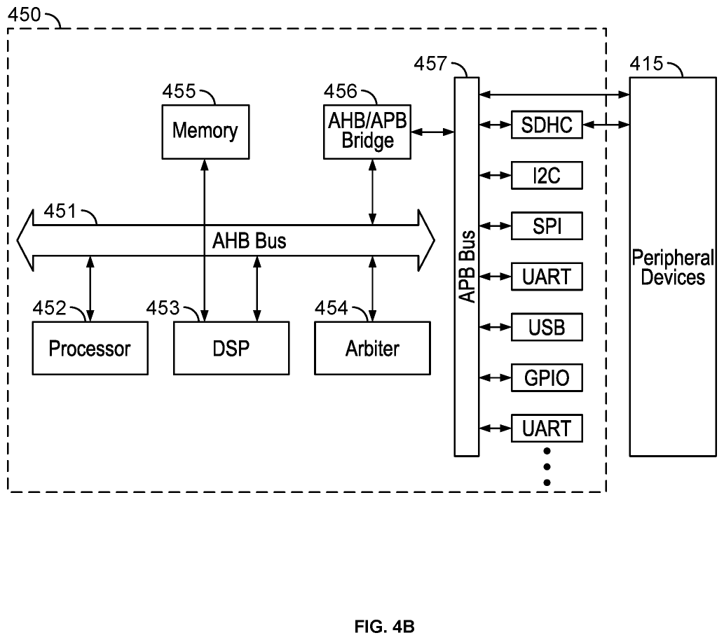

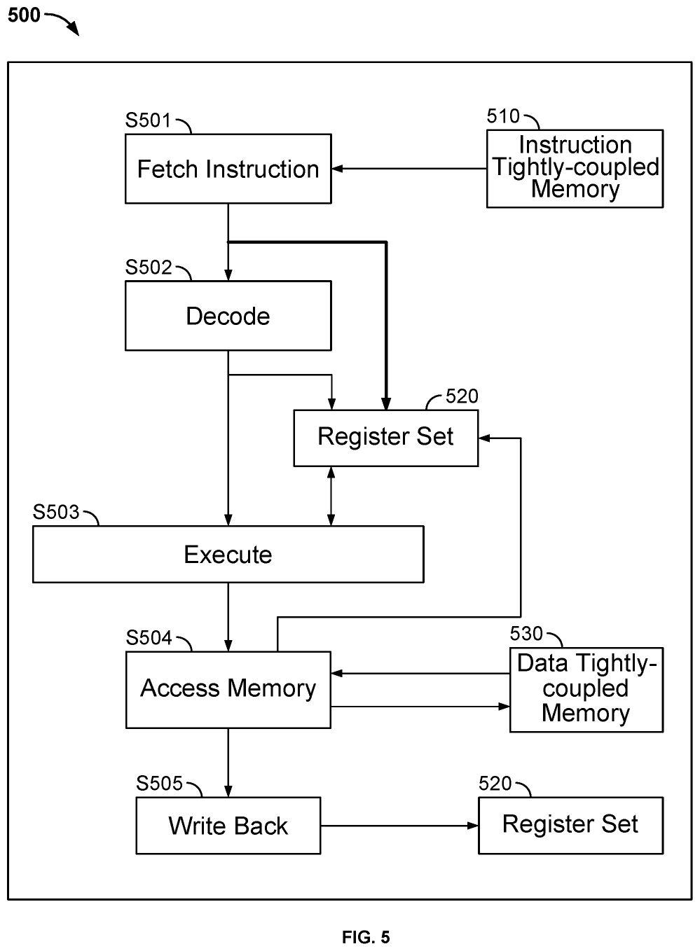

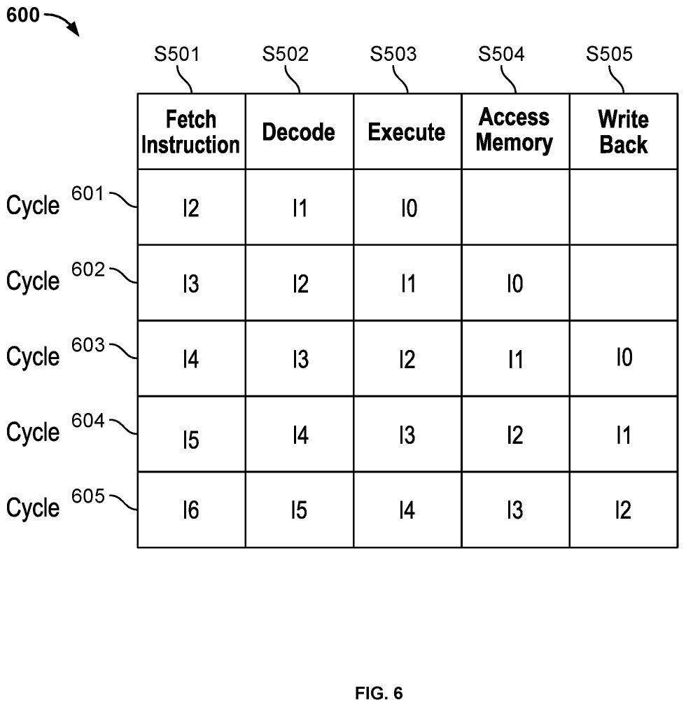

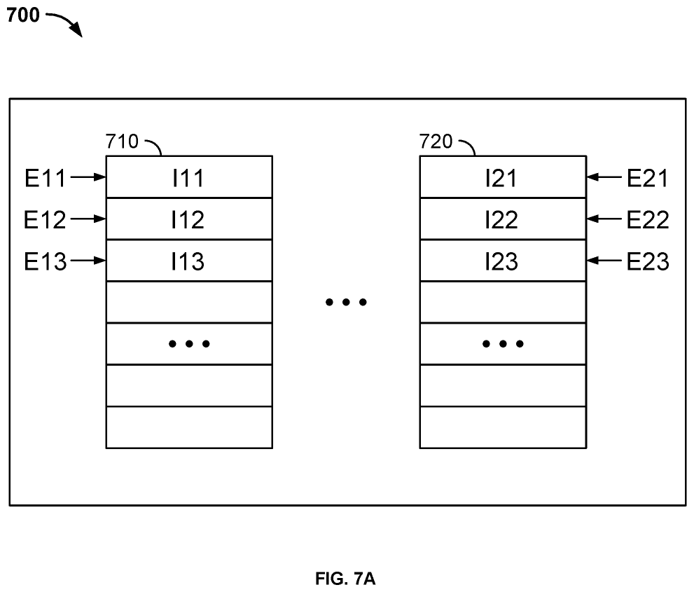

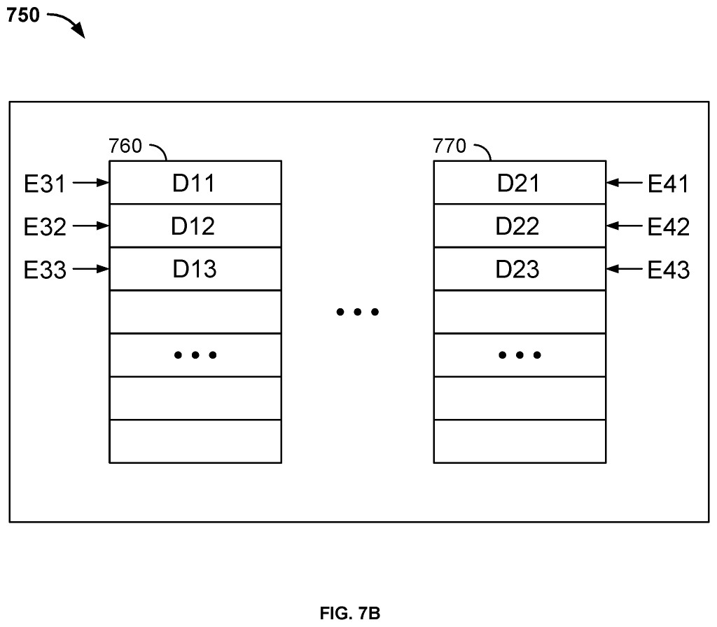

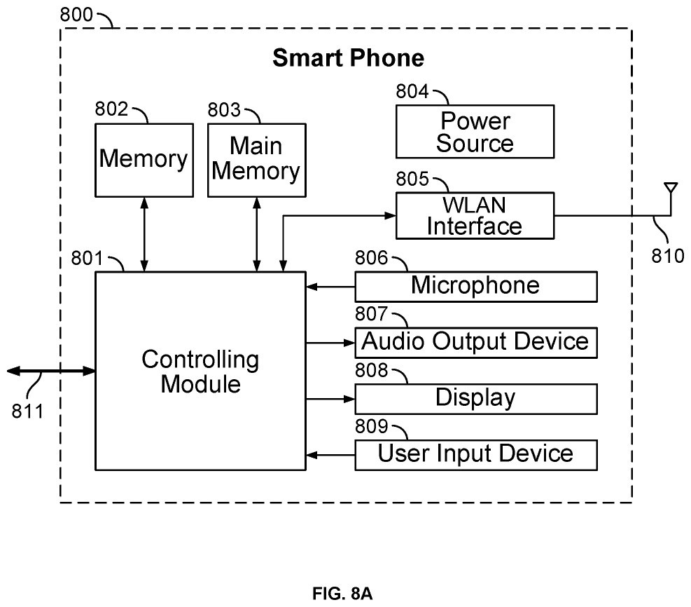

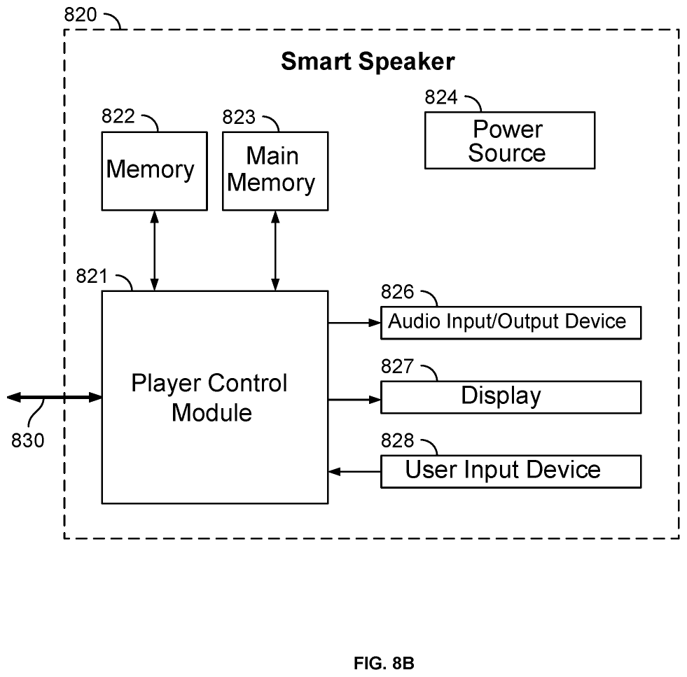

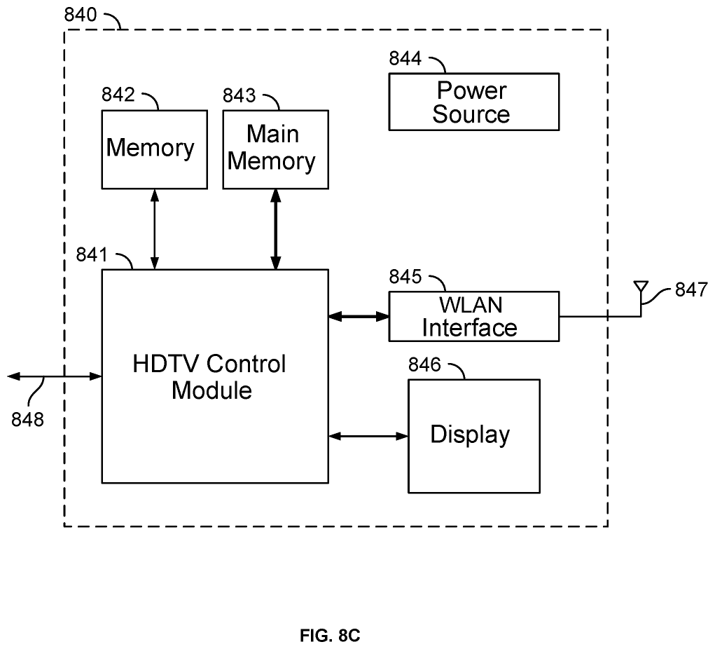

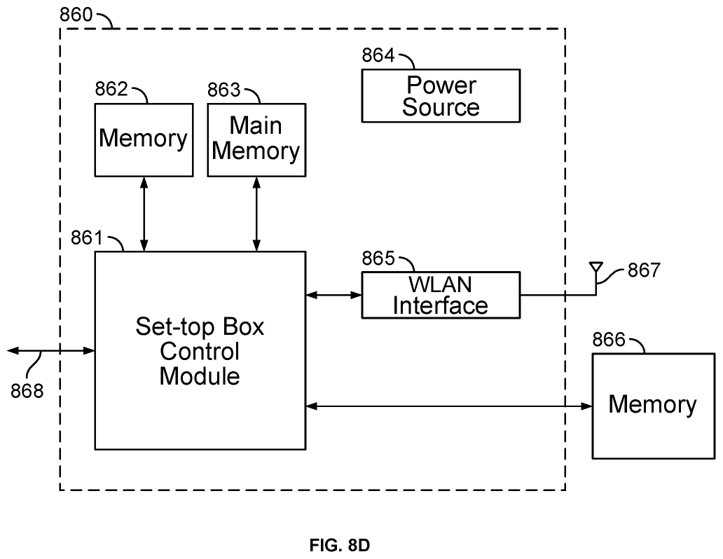

Referring to FIG. 1, processing unit 100 is provided. Processing unit 100 can implement processor core 200 of FIG. 2. Processing unit 100 can be implemented in processing system 300 of FIG. 3, processing system 400 of FIG. 4A, processing system 450 of FIG. 4B, and/or method 500 of FIG. 5. Processing unit 100 can execute one or more instructions based at least in part on instruction pipeline 600 of FIG. 6. For example, processing unit 100 can communicate with instruction tightly-coupled memory 700 of FIG. 7A, and/or data information from data tightly-coupled memory 750 of FIG. 7B (e.g., in connection with obtaining information associated with an instruction that is to be executed at least in part by processing unit 100). For example, processing unit 100 can obtain (or be provided with) instruction information from instruction tightly-coupled memory 700 of FIG. 7A, and/or obtain (or be provided with) data information data from tightly-coupled memory 750 of FIG. 7B. Processing unit 100 can be included in electronic device 800 of FIG. 8A, electronic device 820 of FIG. 8B, electronic device 840 of FIG. 8C, and/or electronic device 860 of FIG. 8D.

As illustrated in FIG. 1, processing unit 100 comprises processor core 110, instruction tightly-coupled memory 120, and data tightly-coupled memory 130. Processor core 110 can correspond to the core portion of generally any type of processor. For example, cores of various types of processors can be implemented as processor core comprised in processing unit 100. A processor type is determined based at least in part on an instruction set architecture implemented by the processor. Examples of instruction set architectures include Complex Instruction Set Computer (CISC) architecture, Reduced Instruction Set Computer (RISC) architecture, and Very Long Instruction Word (VLIW) architecture. Various other instruction set architectures can be implemented. According to various embodiments, a processor (e.g., processing unit 100) only processes instructions included in the corresponding instruction set architecture. For example, the instruction set architecture defines the instructions that can be processed by the processor.

A compiler compiles program code into executable code. As an example, a compiler compiles program code into instruction combinations supported by a particular instruction set architecture (e.g., the instruction set architecture corresponding to the processor). Processor core 110 can be manufactured using one or more processing technologies. Product manufacturing is aided through sufficiently detailed rendering on machine-readable media.

According to various embodiments, processor core 110 is connected to instruction tightly-coupled memory 120 and data tightly-coupled memory 130 via one or more buses. In some embodiments, processor core 110 is connected to instruction tightly-coupled memory 120 and data tightly-coupled memory 130 via separate buses. The respective buses connecting processor core 110 to instruction tightly-coupled memory 120 and data tightly-coupled memory 130 can be dedicated buses for respectively communicating information between processor core 110 and instruction tightly-coupled memory 120, and information between processor core 110 and data tightly-coupled memory 130.

As illustrated in FIG. 1, processor core 110 is connected to instruction tightly-coupled memory 120 through bus 140 and to data tightly-coupled memory 130 through bus 150. In some embodiments, buses 140 and 150 are used to represent the interworking units that connect the processor core 110 to other components and do not necessarily designate two physical buses. Rather, many implementations of connecting processor core 110 and instruction tightly-coupled memory 120 and data tightly-coupled memory 130 are possible (e.g., multiple physical buses or a bus matrix composed of multiple physical buses). Buses 140 and 150 are used in connection with transmitting digital signals between the processor core and tightly-coupled memory. In some embodiments, instruction tightly-coupled memory 120 is limited to storing instruction information only, and the data tightly-coupled memory 130 is limited to storing data information only. According to various embodiments, bus 140 is used in connection with communicating digital signals representing instruction information between instruction tightly-coupled memory 120 and processor core 110, and bus 150 is used in connection with communicating digital signals representing data information between the data tightly-coupled memory 130 and the processor core 110. Buses 140 and 150 can respectively correspond to independent data channels. For example, buses 140 and 150 can respectively correspond to independent data channels having different data bus widths. In addition, although the drawing depicts the instruction tightly-coupled memory 120 as an independent device external to processor core 110, instruction tightly-coupled memory 120 can be disposed within processor core 110, or processor core 110 and instruction tightly-coupled memory 120 can be integrated to form a new component.

According to various embodiments, in connection with operation of processor core 110, processor core 110 reads instruction information stored in the instruction tightly-coupled memory 120 (e.g., via bus 140) and reads data information stored in the data tightly-coupled memory 130 (e.g., via bus 150). Processor core 110 uses instruction information (e.g., obtained from instruction tightly-coupled memory 120) as a basis to execute corresponding operations on the data information (e.g., obtained from data tightly-coupled memory 130) in order to implement set functions of the instructions. Processor core 110 can determine one or more operations to execute on the data information based at least part on the instruction information.

FIG. 2 is a diagram of a processor core according to various embodiments of the present application.

Referring to FIG. 2, processor core 200 is provided. Processor core 200 can be implemented in processing unit 100 of FIG. 1. In some embodiments, processor core 200 corresponds to processor core 110 of FIG. 1. Processor core 200 can be implemented in processing system 300 of FIG. 3, processing system 400 of FIG. 4A, processing system 450 of FIG. 4B, and/or method 500 of FIG. 5. Processor core 200 can execute one or more instructions based at least in part on instruction pipeline 600 of FIG. 6. For example, processor core 200 can communicate with instruction tightly-coupled memory 700 of FIG. 7A, and/or data information from data tightly-coupled memory 750 of FIG. 7B (e.g., in connection with obtaining information associated with an instruction that is to be executed at least in part by processor core 200). For example, processor core 200 can obtain (or be provided with) instruction information from instruction tightly-coupled memory 700 of FIG. 7A, and/or obtain (or be provided with) data information from data tightly-coupled memory 750 of FIG. 7B. Processor core 200 can be included in electronic device 800 of FIG. 8A, electronic device 820 of FIG. 8B, electronic device 840 of FIG. 8C, and/or electronic device 860 of FIG. 8D.

As illustrated in FIG. 2, processor core 200 comprises executing unit 210, register set 220, and decoder 230. In some embodiments, executing unit 210 comprises packaged instruction set 215.

In some embodiments, instructions (e.g., packaged instruction set 215) that are packaged in the executing unit 210 depend on the instruction set architecture used. Examples of instruction set architectures that can be implemented include CISC, RISC, and VLIW. Other instruction set architectures are possible. In some embodiments, the implemented instruction set architecture corresponds to an architecture combining two or more instruction sets (e.g., a combination of two or more of CISC, RISC, and VLIW). Accordingly, packaged instruction set 215 can correspond to a complex instruction set, a reduced instruction set, a very long instruction word, or a combination thereof.

In some embodiments, executing unit 210 is connected to register set 220 and decoder 230 via one or more buses. The one or more buses can be internal buses. Executing unit 210 uses instruction information and data information to execute corresponding operations. In some embodiments, the instruction information and data information can be stored on register set 220.

Register set 220 can correspond to a storage area on processor core 200. In some embodiments, register set 220 stores instruction information, data information, and intermediate and final results associated with operations. In some embodiments, in response to processor core 200 obtaining instruction information from a tightly-coupled memory, and obtaining data information from data tightly-coupled memory, the instruction information and data information are respectively stored in register set 220.

In some embodiments, decoder 230 interprets an instruction that is to be executed and sets the corresponding tasks in motion. Decoder 230 (e.g., an instruction decoder) is connected to the register set 220. According to various embodiments, decoder 230 interprets operations corresponding to instructions. For example, decoder 230 indicates a type of operation that is to be executed on the corresponding data. Decoder 230 can decode instructions received by processor core 200 into control signals and/or microcode entry points. Decoder 230 can provide the control signals and/or microcode entry points to executing unit 210. In response to obtaining the control signals and/or microcode entry points, executing unit 210 implements corresponding flow control.

According to various embodiments, instruction information and data information used in connection with executing instructions are stored separately across one or more memories. In some embodiments, instruction tightly-coupled memory only stores instruction information and the data tightly-coupled memory only stores data information. Accordingly, instruction information and data information are stored separately to facilitate access to instruction information and data information.

FIG. 3 is a diagram of a processing system according to various embodiments of the present application.

Referring to FIG. 3, processing system 300 is provided. Processing system 300 can implement processing unit 100 of FIG. 1, and/or processor core 200 of FIG. 2. Processing system 300 can execute one or more instructions based at least in part on instruction pipeline 600 of FIG. 6. Processing system 300 can implement instruction tightly-coupled memory 700 of FIG. 7A, and/or data information from data tightly-coupled memory 750 of FIG. 7B (e.g., in connection with obtaining information associated with an instruction that is to be executed at least in part by processing system 300). For example, processor core 310 can obtain (or be provided with) instruction information from instruction tightly-coupled memory 700 of FIG. 7A, and/or obtain (or be provided with) data information from data tightly-coupled memory 750 of FIG. 7B. Processing system 300 can be included in electronic device 800 of FIG. 8A, electronic device 820 of FIG. 8B, electronic device 840 of FIG. 8C, and/or electronic device 860 of FIG. 8D.

As illustrated in FIG. 3, processing system 300 comprises processor core 310, instruction tightly-coupled memory 350, and data tightly-coupled memory 360. Processing system 300 can further comprise one or more of memory protection unit 320, high-speed cache 330, system bus interface 340, instruction bus unit 370, and/or DMA controller 380. In some embodiments, processing system 300 comprises processing unit 100 of FIG. 1, and/or processor core 200 of FIG. 2. For example, processor core 310 can correspond to processor core 200.

According to various embodiments, processing system 300 can be implemented as, or as part of, a processor, a graphics processor, a microcontroller, a microprocessor, a digital signal processor (DSP), or processors custom-made for specific purposes. Processing system 300 can also be used to form a system-on-a-chip (SoC), a computer, hand-held devices, and embedded products. Processing system 300 can be implemented in an electronic device. Examples of computers include desktop computers, servers, and workstations. Examples of hand-held devices and embedded products include cellular telephones, Internet protocol devices, digital cameras, personal digital assistants (PDAs), hand-held PCs, network computers (NetPCs), set-top boxes, network hubs, and wide area network (WAN) switches.

FIG. 3 illustrates processing system 300 including a processor core 310, a memory protection unit 320, high-speed cache 330, a system bus interface 340, instruction tightly-coupled memory 350, data tightly-coupled memory 360, an instruction bus unit 370, and a direct memory access (DMA) controller 380. Processing system 300 can further comprise one or more internal buses that connect the components of processing system 300. Processor core 310, instruction tightly-coupled memory 350, and data tightly-coupled memory 360 can respectively correspond to processor core 110, instruction tightly-coupled memory 120, and data tightly-coupled memory 130 of processing unit 100 of FIG. 1.

According to various embodiments, processor core 310 can correspond to a core portion of any type of processor. Types of processors include processors having a CISC architecture, a RISC architecture, or a VLIW architecture, or a combination of one or more of the foregoing architectures. Various other types of processors and/or instruction set architectures can be implemented.

Instruction bus unit 370 is communicatively connected to the processor core 310 and is configured to transmit instruction information to processor core 310, etc. Instruction bus unit 370 can obtain information pertaining to an instruction to be performed from an input to processing system 300 (e.g., from an element outside processing system 300), and communicate the information pertaining to the instruction to be performed to one or more elements of processing system 300 such as processor core 310. The information pertaining to an instruction to be performed can be provided to processing system 300 from an application running on the electronic device, in response to a user input to an interface of the electronic device, etc. In some embodiments, instruction information can only be fetched from external memory to the processor core 310 through the instruction bus unit 370. In some embodiments, instruction bus unit 370 is a one-way bus to facilitate the fetching of instruction information from external memory (e.g., memory that is external to processing system 300).

Memory protection unit 320 is communicatively connected to processor core 310, high-speed cache 330, instruction tightly-coupled memory 350, and data tightly-coupled memory 360. Memory protection unit 320 is used in connection with protecting sensitive instruction information and data information internally transmitted within the processing system 300. Memory protection unit 320 can correspond to a hardware unit that provides memory protection. In some embodiments, memory protection unit 320 allows the privileged software to define memory regions and assign memory access permission and memory attributes to each of the memory regions. Memory protection unit 320 can prevent a process from accessing memory that has not been allocated to the memory. For example, memory protection unit 320 monitors transactions, including instruction fetches and data accesses from processor core 310, which can trigger a fault exception when an access violation is detected.

High-speed cache 330 is communicatively connected to processor core 310 and the system bus interface 340. High-speed cache 330 is used in connection with temporary storage of various kinds of data information and instruction information. In some embodiments, the instruction information and data information are loaded from external memory (e.g., hard drives or flash memory). The external memory can be external with respect to processing system 300. As an example, various kinds of instruction information and data information are loaded through the system bus interface 340 from external memory or from other memory (such as flash memory) internal to the processing system 300.

System bus interface 340 is a connection circuit between processing system 300 and the system bus. Examples of types of interfaces corresponding to the system bus interface 340 include a general-purpose input/output (GPIO) interface, a universal asynchronous receiver/transmitter (UART) interface, an I2C bus interface, a serial peripheral interface (SPI), a flash interface, and an LCD interface. Various other types of interfaces can be implemented for system bus interface 340. In some embodiments, system bus interface 340 includes a plurality of types of interfaces. Various peripheral devices communicatively connect to processing system 300 through system bus interface 340. For example, the UART interface conducts data communications with a universal asynchronous receiver/transmitter, while communications with the display controller are conducted via the LCD interface.

Instruction tightly-coupled memory 350 stores instruction information, and data tightly-coupled memory 360 stores data information. In some embodiments, instruction tightly-coupled memory 350 is limited to storing instruction information only, and data tightly-coupled memory 360 is limited to storing data information only. Data tightly-coupled memory 360 is connected to the DMA controller 380. DMA controller 380 is connected to an external memory (not shown). According to various embodiments, DMA controller 380 obtains data from one or more external memories and provides the data to one or more elements or modules in processing system 300. DMA controller 380 can obtain data information from the external memory and the data information can be communicated from DMA controller 380 to data tightly-coupled memory 360. Data tightly-coupled memory 360 can thus acquire data information from external memory (e.g., via DMA controller 380). In some embodiments, instruction tightly-coupled memory 350 is communicatively coupled to DMA controller 380. Instruction tightly-coupled memory 350 can similarly use the DMA controller 380 to obtain instruction information from external memory. In some embodiments, high-speed cache 330 is communicatively coupled to DMA controller 380. High-speed cache 330 can similarly use DMA controller 380 or the system bus interface 340 to obtain information from external memory.

In some embodiments, processor core 310 obtains instruction information via instruction bus unit 370 in connection with processor core 310 operating (e.g., in connection with processor core 310 performing one or more operations). Processor core 310 can obtain instruction information and data information from the high-speed cache 330 through memory protection unit 320. Processor core 310 can obtain instruction information from instruction tightly-coupled memory 350 through memory protection unit 320 and data information from data tightly-coupled memory 360. In some embodiments, processor core 310 bypasses memory protection unit 320 and directly accesses high-speed cache 330 (e.g., processor core 310 directly obtains instruction information and/or data information from the high-speed cache 330 without communicating with the high-speed cache 330 via memory protection unit 320. The particular manner of execution is decided by processor core 310 processing logic and the instruction content.

In some embodiments, a determination of whether the memory protection unit 320 can be bypassed is based at least in part on whether firmware is pre-configured. For example, whether the memory protection unit 320 can be bypassed is a function that can be pre-configured in the firmware. For example, a system-on-a-chip (SOC) can pre-configured to disable memory protection unit 320. Some user scenarios does not need to enable or initiate a memory protection unit 320 if no sensitive data is needed to be monitored. As another example, a SOC has a trusted execution environment (TEE) that is used to store user confidential information. In such a SOC, the memory protection unit 320 can be disables because normal data is stored in the cache and confidential information is stored in the TEE.

Processing system 300 can include neither the memory protection unit 320 nor the high-speed cache 330, a single one of memory protection unit 320 and high-seed cache 330, or both memory protection unit 320 and high-seed cache 330. In addition, if the DMA controller is used to obtain data information, hardware devices can directly access external memory without involving (e.g., using) a processor. Therefore, according to various embodiments, if data tightly-coupled memory 360 reads data information from external memory, processor core 310 can perform another operation. For example, if data tightly-coupled memory 360 reads data information from external memory, processor core 310 is available for performing one or more other operations. Such an approach can help to further improve the execution efficiency of processing system 300. In some embodiments, only peripheral devices with large data flows need to support the DMA controller. Examples of applications corresponding to large data flows (e.g., that generally interact with such peripheral devices) include video, audio, and network interfaces. According to various embodiments, a DMA controller is set up outside processing system 300 (e.g., DMA controller is configured external to processing system 300). For example, one or more DMA controllers are configured set up outside a processor in a PC system.

According to various embodiments, data stored in tightly-coupled memory has greater predictability compared to similar data stored in a high-speed cache. Although there is little difference in access speed between high-speed cache and a tightly-coupled memory, the data stored in tightly-coupled memory has greater predictability. “Predictability” refers to the ability of program code to precisely control the storage and reading of data information in tightly-coupled memory. Data information in a high-speed cache can randomly change and cannot be controlled by program code. For example, information in high-speed cache is highly dynamic, and therefore the control of the storage and the reading of data information cannot be accurately “predicted.” In contrast, in some embodiments, data stored in the TCM normally does change so with as often as information stored in the high-speed cache. Accordingly, various embodiments have higher predictability and can operate more efficiently than related art systems that store information in a high-speed cache rather than a TCM. In some embodiments, key instruction information and data information are stored in tightly-coupled memory (e.g., instruction tightly-coupled memory 350 and data tightly-coupled memory 360) to ensure that such instruction information and data information can be used in a controlled manner. As used herein, according to various embodiments, key instruction information refers to important and/or critical instruction information, and/or important and/or critical data information. In some embodiments, the instruction information and data information can be used in a controlled manner because the processor knows to pull the instruction information and the data information from the corresponding tightly-coupled memory (e.g., the instruction tightly-coupled memory 350 and data tightly-coupled memory 360).

In some embodiments, high-speed cache 330 is divided into L1 cache and L2 cache. Moreover, each level of cache can be further divided into an instruction cache and a data cache. The L1 cache can be located on a system-on-a-chip, and the L2 cache can be located off the chip. In response to determining that instruction information or data information is needed by processor core 310, a location of such instruction information or data information is determined (e.g., it is determined whether such instruction information or data information is stored in the L1 cache or the L2 cache). In response to a determination that the instruction information needed by processor core 310 is not in the L1 cache, or that data information needed by processor core 310 is not in the L1 cache, such instruction information or data information is obtained from the L2 cache.

If tightly-coupled memory is divided into a data tightly-coupled memory and an instruction tightly-coupled memory, respective capacity settings for the data tightly-coupled memory and the instruction tightly-coupled memory are considered. For example, capacity settings for the data tightly-coupled memory and the instruction tightly-coupled memory are considered and can be adjusted according to storage or processing requirements. Tightly-coupled memory has a corresponding upper-limit of an amount of capacity. The upper limit of the amount of capacity for a tightly-coupled memory is lower than the upper limit of the amount of capacity of a high-speed cache because of the cost constraints associated with tightly-coupled memory. Tightly-coupled memory is more costly than other types of memory such as a high-speed cache. As a result, a processing system has less capacity available for tightly-coupled memory. Capacity for the tightly-coupled memory of a processing system 300 is allocated between instruction tightly-coupled memory and data tightly-coupled memory. For example, capacities need to be allocated to data tightly-coupled memory and instruction tightly-coupled memory in a way that meets the precondition of the upper limit of the amount of capacity of the tightly-coupled memory and the respective system requirements for instruction tightly-coupled memory and data tightly-coupled memory. According to conventional art, capacity of instruction tightly-coupled memory generally far exceeds the capacity of data tightly-coupled memory. As an illustrative example of conventional art, instruction tightly-coupled memory capacity may be 128 kb, and data tightly-coupled memory capacity may be 64 kb. However, experiments of implementations of various embodiments have shown that the capacity of instruction tightly-coupled memory can be reduced to less than the capacity of data tightly-coupled memory. For example, in contrast to the illustrative example above, data tightly-coupled memory capacity can be set to 128 kb, and instruction tightly-coupled memory can be set to 64 kb. Such an adjustment is particularly useful if less instruction information and more data information exists or is needed. Therefore, according to various embodiments, the memory respectively allocated to instruction tightly-coupled memory and data tightly-coupled memory can be adjusted. The allocation of memory to instruction tightly-coupled memory and data tightly-coupled memory can be adjusted according to system requirements (e.g., amount of instruction information, amount of data information, or a relative amount of instruction information versus data information, etc.).

According to various embodiments, if the capacity of memory allocated to data tightly-coupled memory is increased (e.g., the space of the data tightly-coupled memory is increased), DMA 380 controller will have more space in which to perform operations on data. Therefore, DMA controller 380 and processor core 310 can simultaneously operate the data tightly-coupled memory. For example, DMA controller 380 and processor core 310 can move data and perform calculations in parallel.

In some embodiments, data tightly-coupled memory is divided into multiple (two or more) independent data tightly-coupled memories. Further, multiple DMA controllers can be set up (e.g., configured). Configuration of the multiple DMA controllers can occur during the process of core design. To further increase processing efficiency, data is moved from external memory within a single clock cycle via the DMA controller. The use of multiple DMA controllers can permit for greater throughput in moving data from external memory in a single clock cycle.

According to various embodiments, the instruction tightly-coupled memory and the data tightly-coupled memory can simultaneously store instructions and data for multiple applications (apps). If available tightly-coupled memory storage space is insufficient for system requirements, the instructions of one or more apps can be divided into core instructions and secondary instructions. In some embodiments, the instructions of each app are divided into core instructions and secondary instructions. The core instructions and secondary instructions can be stored in different memories. For example, the instruction information of the core instructions is stored in instruction tightly-coupled memory, and the instruction information of the secondary instructions is stored in external memory. The data information of the core instructions is stored in data tightly-coupled memory, and the data information corresponding to the secondary instructions is stored in external memory.

According to various embodiments, information can be classified based at least in part on a type of app, a status of an app, statistics pertaining to apps (e.g., historical usage, usage requirements, etc.), etc. In some embodiments, the basic status and statistics of apps are used to classify instructions into different levels. As an example, a plurality of apps can be classified according to app basic status (e.g., initialization instructions and closing instructions performed after the app finishes running). As another example, a plurality of apps can be classified using a software simulator and FPGA simulation to calculate the number of function invokes and computing consumption of each function in a particular app. Instructions that consume a high level of computing power and have frequent invokes (e.g., high call frequencies) generally tend to gather together. The instruction levels are then decided on the basis of instruction tightly-coupled memory capacity and experimental results. For example, the experimental results can be obtained during the design/test process. In some cases, the experimental results are obtained by using the above-mentioned simulation work results. The designer team can classify the instructions based on the result data calculated from the test, or from the real operation history (collected by the applications). The separate storage of instructions according to instruction level can effectively improve the execution efficiency of the processing unit or processing system.

FIG. 4A is a diagram of a processing system according to various embodiments of the present application.

Referring to FIG. 4A, processing system 400 is provided. Processing system 400 can implement processing unit 100 of FIG. 1, and/or processor core 200 of FIG. 2. Processing system 400 can execute one or more instructions based at least in part on instruction pipeline 600 of FIG. 6. Processing system 400 can implement instruction tightly-coupled memory 700 of FIG. 7A, and/or data information from data tightly-coupled memory 750 of FIG. 7B (e.g., in connection with obtaining information associated with an instruction that is to be executed at least in part by processing system 400). For example, processor 402 can obtain (or be provided with) instruction information from 700 of FIG. 7A, and/or obtain (or be provided with) data information from data tightly-coupled memory 750 of FIG. 7B. Processing system 400 can be included in electronic device 800 of FIG. 8A, electronic device 820 of FIG. 8B, electronic device 840 of FIG. 8C, and/or electronic device 860 of FIG. 8D.

Processing system 400 can implement various embodiments. Processing system 400 can be a computer system. As illustrated in FIG. 4A, processing system 400 is an example of “hub” system architecture. Various processing system architectures can be implemented in connection with various embodiments. Processing system 400 can be built on the basis of various models of processors currently on the market and can be driven by an operating system. The operating system can be a version of a Windows™ operating system, a Unix operating system, or a Linux operating system. Various other operating systems can be implemented. In addition, processing system 400 is generally implemented on a PC, a desktop computer, a notebook computer, or a server.

According to various embodiments, processing system 400 includes processor 402. Processor 402 can have a data processing capability according to processors of conventional art. Various instruction architectures can be implemented in connection with processor 402. For example, processor 402 can be a processor with CISC architecture, RISC architecture, or VLIW architecture, or a combination of one or more of the foregoing instruction set architectures. In some embodiments, processor 402 is a processor device designed and built for a special purpose.

As illustrated in FIG. 4A, processor 402 is connected to system bus 401. System bus 401 can transmit data signals between processor 402 and other components (e.g., other components of a computing system). According to various embodiments, processor 402 includes processing unit 100 of FIG. 1 or processor core 200 of FIG. 2, or a variation of an embodiment based thereon.

Processing system 400 can further include memory 404 and/or a display card 405. Memory 404 can be a dynamic random access memory (DRAM) device, a static random access memory (SRAM) device, a flash memory device, or other memory device. Memory 404 can store instruction information and/or data information. For example, memory 404 can store the instruction information and or data information expressed as data signals. Display card 405 includes a display driver, which is configured to control correct display of display signals on a display screen that is connected to processing system 400.

Display card 405 and memory 404 are connected to system bus 401 through memory controller hub 403. Processor 402 can communicate with the memory controller hub 403 through system bus 401 or another bus. Memory controller hub 403 provides memory 404 with a high bandwidth memory access path 421 for storing and reading instruction information and data information. In addition, the memory controller hub 403 and the display card 405 transmit display signals on the basis of the display card signal input/output interface 420. The display card signal input/output interface 420 is, for example, a DVI, HDMI, or similar interface. Various other input/output interfaces can be implemented.

In addition to transmitting digital signals between the processor 402, memory 404, and the display card 405, memory controller hub 403 also implements bridging of digital signals for system bus 401, memory 404, and input/output controller hub 406.

Processing system 400 further includes the input/output controller hub 406. Input/output controller hub 406 connects to the memory controller hub 403 through special-purpose hub interface bus 422. Moreover, some I/O devices are connected to the input/output controller hub 406 through local I/O buses. The local I/O buses peripheral devices can be connected to the input/output controller hub 406 via local I/O buses. Input/output controller hub 406 connects to memory controller hub 403 and system bus 401. Various peripheral devices can be implemented in connection with processing system 400. Examples of peripheral devices include, but are not limited to the following devices: hard drive 407, optical disk drive 408, sound card 409, serial expansion port 410, audio controller 411, keyboard 412, mouse 413, GPIO interface 414, flash memory 415, and network card 416.

Of course, the structural diagrams of different computer systems will vary according to differences in motherboard, operating system, and instruction set architecture. For example, a computer system can integrate memory controller hub 403 into processor 402. In this way, the input/output controller hub 406 becomes a control hub connected to processor 402.

FIG. 4B is a diagram of a processing system according to various embodiments of the present application.

Referring to FIG. 4B, processing system 450 is provided. Processing system 450 can implement processing unit 100 of FIG. 1, and/or processor core 200 of FIG. 2. Processing system 450 can execute one or more instructions based at least in part on instruction pipeline 600 of FIG. 6. Processing system 450 can implement instruction tightly-coupled memory 700 of FIG. 7A, and/or data information from data tightly-coupled memory 750 of FIG. 7B (e.g., in connection with obtaining information associated with an instruction that is to be executed at least in part by a processor or processing system). For example, processor 452 can obtain (or be provided with) instruction information from 700 of FIG. 7A, and/or obtain (or be provided with) data information from data tightly-coupled memory 750 of FIG. 7B. Processing system 450 can be included in electronic device 800 of FIG. 8A, electronic device 820 of FIG. 8B, electronic device 840 of FIG. 8C, and/or electronic device 860 of FIG. 8D.

According to various embodiments, processing system 450 is a system-on-a-chip. As an example, a system-on-a-chip can refer to an integrated circuit that integrates all or most components of a computer or other electronic system. The components integrated in the integrated circuit almost always include a central processing unit, memory, input/output ports and secondary storage—all on a single substrate or microchip.

According to various embodiments, processing system 450 can be formed using any of several models of processor currently on the market. Moreover, processing system 450 can be driven by an operating system. The operating system can be a version of a Windows™ operating system, a Unix operating system, an Android operating system, or a Linux operating system. Various other operating systems can be implemented. In addition, processing system 450 can be implemented in a hand-held device or an embedded product. Examples of hand-held devices include cellular telephones, Internet protocol devices, digital cameras, personal digital assistants (PDAs), and hand-held PCs. Embedded products may include network computers (NetPCs), set-top boxes, network hubs, wide area network (WAN) switches, or any other system capable of executing one or more instructions.

As illustrated in FIG. 4B, processing system 450 includes a processor 452, digital signal processor (DSP) 453, arbiter 454, memory 455, and an AHB/APB bridge 456. Processor 452, digital signal processor (DSP) 453, arbiter 454, memory 455, and an AHB/APB bridge 456 can be respectively connected through the AHB (advanced high-performance bus or system bus) bus 451. According to various embodiments, one or both of the processor 452 and the DSP 453 can include the processing unit 100 of FIG. 1, or processor core 200 of FIG. 2, or a variation of an embodiment based thereon.

Various instruction architectures can be implemented in connection with processor 452. For example, processor 452 can be a CISC microprocessor, a RISC microprocessor, a VLIW microprocessor, a microprocessor that implements a combination of one or more of the foregoing instruction sets, or any other processor device.

The AHB bus 451 is configured to transmit digital signals between high-performance modules of processing system 450. For example, AHB bus 451 is used in connection with transmitting information (e.g., digital signals) among at least two of the processor 452, the DSP 453, the arbiter 454, memory 455, and the AHB/APB bridge 456.

Memory 455 is configured to store instruction information and/or data information. For example, instruction information and/or data information is expressed as digital signals and stored in memory 455. Various memories can be implemented as memory 455. For example, memory 455 can be a dynamic random access memory (DRAM) device, a static random access memory (SRAM) device, a flash memory device, or other memory device. DSP 453 can access memory 455 through the AHB bus 451 or via one or more other connections between DSP 453 and memory 455.

Arbiter 454 is configured to control access of processor 452 and DSP 453 to AHB bus 451. Because both the processor 452 and the DSP 453 can control other components via AHB bus 451, one or more of processor 452 and DSP 453 require confirmation from the arbiter 454 to do so.

AHB/APB bridge 456 performs data transmission bridging between the AHB bus 451 and APB bus 457. Specifically, AHB/APB bridge 456 converts the AHB protocol into the APB protocol by latching addresses, data, and control signals from the AHB bus 451 and providing secondary decoding to generate APB peripheral device selection signals.

Processing system 450 can also include various interfaces connected to APB bus 457. Examples of various interfaces connected to APB bus 457 include the following types of interfaces: a secure digital high capacity (SDHC) interface, I2C bus, a serial peripheral interface (SPI), a universal asynchronous receiver/transmitter (UART) interface, a universal serial bus (USB) interface, a general-purpose input/output (GPIO) interface, and Bluetooth UART. Various other interfaces can be implemented. Examples of peripheral devices 415 connected to the various interfaces connected to APB bus 457 include USB devices, memory cards, message transmitters and receivers, and Bluetooth devices. Various other peripheral devices can be implemented and connected to processing system 450 via the various interfaces connected to APB bus 457.

FIG. 5 is a flowchart of a method for a processing system to execute instructions according to various embodiments of the present application.

Referring to FIG. 5, method 500 is provided. Method 500 can be implemented by processing unit 100 of FIG. 1, and/or processor core 200 of FIG. 2. Method 500 can be implemented in connection with executing one or more instructions based at least in part on instruction pipeline 600 of FIG. 6. Method 500 can include processing using instruction tightly-coupled memory 700 of FIG. 7A, and/or data information from data tightly-coupled memory 750 of FIG. 7B (e.g., in connection with obtaining information associated with an instruction that is to be executed at least in part by processing system 450). For example, method 500 can obtain (or be provided with) instruction information from 700 of FIG. 7A, and/or obtain (or be provided with) data information from data tightly-coupled memory 750 of FIG. 7B. Method 500 can be implemented by electronic device 800 of FIG. 8A, electronic device 820 of FIG. 8B, electronic device 840 of FIG. 8C, and/or electronic device 860 of FIG. 8D.

According to various embodiments, method 500 corresponds to the processing process of a five-stage instruction pipeline. The description hereof with respect to method 500 is an example of processing that is implemented. According to various embodiments, various instructions can be processed at different time periods.

At S501, instruction information is fetched from an instruction tightly-coupled memory 51. In response to fetching the instruction information, the instruction information can be put into an instruction register (IR) (e.g., the IR can be included in register set 52). According to various embodiments, the processor (e.g., processor core 110 of FIG. 1, processor core 200 of FIG. 2, etc.) fetches the instruction information. The instruction information is fetched from a pre-stored or pre-defined memory address. For example, the instruction information is fetched from the memory address that is currently stored in a program counter. The instruction information can comprise one or more instructions.

At S502, at least part of the instruction information is decoded. For example, one or more instructions are obtained from the instruction information and decoded. In some embodiments, the instruction register is read, and the read results are put into a temporary register (included in the register set 52). For example, a decoder (e.g., decoder 230 of processor core 200 of FIG. 2) reads encoded instructions from the instruction register, decodes the instructions, and puts the results (e.g., the decoded instructions) into the temporary register.

At S503, one or more operations pertaining to the instructions are executed. In some embodiments, a processor implements execution of the one or more operations. The processor can correspond to processor core 110 of FIG. 1, processor core 200 of FIG. 2, etc. The one or more operations can include performing one or more calculations. As an example, the one or more calculations are performed by an arithmetic operation unit of the processor or processing system. In response to performing the one or more operations, the results are stored in a temporary register (e.g., the temporary register can be included in the register set 52). As an example, in response to performing the one or more computations, the results of the computations are stored in the temporary register. According to various embodiments, executing the one or more operations pertaining to the instructions can include reading values from registers, passing the values to an arithmetic logic unit (ALU) to perform mathematical or logic functions on the values, and writing the result back to a register (e.g., the temporary register). If the ALU is used in the processing system, the ALU sends a condition signal back to a control unit (CU) of the processing system. The result generated by the operation is stored in the main memory or sent to an output device. Based on the feedback from the ALU, the processor may be updated to a different address from which the next instruction will be fetched. In some embodiments, the result generated by the operation is stored in data tightly-coupled memory 53.

At S504, information is accessed from memory. In some embodiments, accessing the memory includes performing a read/write operation for data information with respect to data tightly-coupled memory 53. For example, data information is fetched (e.g., read) from data tightly-coupled memory 53 and stored in register set 52, or data information is written from register set 52 into data tightly-coupled memory 53. In some embodiments, calculation results from S503 (which can be stored in the register set 52) is fetched out to the data tightly-coupled 53. Alternatively, new data is flooded from the data tightly-coupled 53 into the register set 52 for a future calculation in another step of executing one or more operations pertaining to the instructions.

At S505, data is written back into the register set 52. In some embodiments, the processing system is updated to include an address of a next instruction to be performed. For example, the address from which the next instruction is to be performed is fetched and stored into register set 52.

FIG. 6 is a space-time diagram of an instruction pipeline used by a processing system according to various embodiments of the present application.

Referring to FIG. 6, instruction pipeline 600 is provided. Instruction pipeline 600 can be implemented by processing unit 100 of FIG. 1, and/or processor core 200 of FIG. 2. Instruction pipeline 600 can be implemented by method 500 of FIG. 5. Instruction pipeline 600 can include using instruction tightly-coupled memory 700 of FIG. 7A, and/or data information from data tightly-coupled memory 750 of FIG. 7B (e.g., in connection with obtaining information associated with an instruction that is to be executed at least in part by a processor or processing system). For example, instruction pipeline 600 can obtain (or be provided with) instruction information from 700 of FIG. 7A, and/or obtain (or be provided with) data information from data tightly-coupled memory 750 of FIG. 7B. Instruction pipeline 600 can be implemented by electronic device 800 of FIG. 8A, electronic device 820 of FIG. 8B, electronic device 840 of FIG. 8C, and/or electronic device 860 of FIG. 8D.

As illustrated in FIG. 6, the horizontal axis represents various steps in a method for a processing system to execute instructions. For example, the horizontal axis can represent steps of method 500 of FIG. 5 (e.g., S501 through S505). The vertical axis space-time diagram of instruction pipeline 600 represents the time periods 601 through 605. According to various embodiments, each of the periods 601 through 605 represents one clock cycle. In some embodiments, the periods 601 through 605 can each represent one or more clock cycles. In the description below of instruction pipeline 600, the time spent by each of the above steps is one clock cycle. According to various embodiments, time spent for any of the steps of a method for a processing system to execute instructions (e.g., S501 through S505 of FIG. 5) can be one or more clock cycles.

As illustrated in FIG. 6, instructions I0 through I2 are executed in cycle 601. In particular, at cycle 601, instruction I0 executes an execution operation (e.g., S503 of method 500), instruction I1 executes a decode operation (e.g., S502 of method 500), and instruction I2 executes a fetch operation (e.g., S501 of method 500). Instructions I0 through I3 are executed in cycle 602. In particular, at cycle 602, instruction I0 executes an access memory operation (e.g., S504 of method 500), instruction I1 executes an execution operation (e.g., S503 of method 500), instruction I2 executes a decode operation (e.g., S502 of method 500), and instruction I3 executes a fetch operation (e.g., S501 of method 500). Instructions I0 through I4 are executed in cycle 603. In particular, at cycle 603, instruction I0 executes a write back operation (e.g., S505 of method 500), instruction I1 executes an access memory operation (e.g., S504 of method 500), instruction I2 executes an execution operation (e.g., S503 of method 500), instruction I3 executes a decode operation (e.g., S502 of method 500), and instruction I4 executes a fetch operation (e.g., S501 of method 500). Instructions I1 through I5 are executed in cycle 604. In particular, at cycle 604, instruction I1 executes a write back operation (e.g., S505 of method 500), instruction I2 executes an access memory operation (e.g., S504 of method 500), instruction I3 executes an execution operation (e.g., S503 of method 500), instruction I4 executes a decode operation (e.g., S502 of method 500), and instruction I5 executes a fetch operation (e.g., S501 of method 500). Instructions I2 through I6 are executed in cycle 605. In particular, at cycle 605, instruction I2 executes a write back operation (e.g., S505 of method 500), instruction I3 executes an access memory operation (e.g., S504 of method 500), instruction I4 executes an execution operation (e.g., S503 of method 500), instruction I5 executes a decode operation (e.g., S502 of method 500), and instruction I6 executes a fetch operation (e.g., S501 of method 500).

According to various embodiments, instructions I0 through I6 include one or more various arithmetic operation instructions (add, subtract, multiply, divide), data access instructions, jump instructions, register operations, and etc. Various other operations can be implemented.

With reference to FIGS. 5 and 6, in cycle 602, instruction I3 executes the operation of fetching instruction information from an instruction tightly-coupled memory, while instruction I0 simultaneously executes the operation of fetching data information from the data tightly-coupled memory. In cycle 603, instruction I4 executes the operation of fetching instruction information from the instruction tightly-coupled memory, while instruction I1 simultaneously executes the operation of fetching data information from the data tightly-coupled memory. In cycle 604, instruction I5 executes the operation of fetching instruction information from the instruction tightly-coupled memory, while instruction I2 simultaneously executes the operation of fetching data information from the data tightly-coupled memory. In cycle 605, instruction I6 executes the operation of fetching instruction information from the instruction tightly-coupled memory, while instruction I3 simultaneously executes the operation of fetching data information from the data tightly-coupled memory.

According to various embodiments, different instructions independently execute the operations of fetching instruction information from the instruction tightly-coupled memory and fetching data information from the data tightly-coupled memory in the same time period (e.g., during the same clock cycle). The two operations (e.g., the operation of fetching instruction information from the instruction tightly-coupled memory and the operation of fetching data information from the data tightly-coupled memory) do not affect each other, nor is it necessary to increase pause periods in the pipeline. Thus, the simultaneous execution of fetching information from the instruction tightly-coupled memory and the data tightly-coupled memory helps to increase processor execution efficiency.

Various embodiments are implemented in execution of a five-stage instruction pipeline. Various multi-state instruction pipelines can be implemented. For example, various embodiments are implemented in connection with execution on another type of multistage instruction pipeline. If a seven-stage pipeline is used, different instructions can still execute the operations of reading instruction information from the instruction tightly-coupled memory and reading data information from the data tightly-coupled memory within the same clock cycle without either operation affecting the other.

FIG. 7A is a diagram of instruction tightly-coupled memory storing instruction information for audio processing and wake-up processing according to various embodiments of the present application.

Referring to FIG. 7A, instruction tightly-coupled memory 700 is provided. Instruction tightly-coupled memory 700 can be implemented in connection with processing unit 100 of FIG. 1, and/or processor core 200 of FIG. 2. Instruction tightly-coupled memory 700 can be implemented by method 500 of FIG. 5 (e.g., instruction tightly-coupled memory 700 can be accessed to fetch instruction information). Instruction tightly-coupled memory 700 can be implemented in connection with data information from data tightly-coupled memory 750 of FIG. 7B (e.g., in connection with obtaining information associated with an instruction that is to be executed at least in part by a processor or processing system). Instruction tightly-coupled memory 700 can be implemented by electronic device 800 of FIG. 8A, electronic device 820 of FIG. 8B, electronic device 840 of FIG. 8C, and/or electronic device 860 of FIG. 8D.

According to various embodiments, instruction tightly-coupled memory 700 stores instruction information relating to audio processing and wake-up processing. Various other instruction information pertaining to various operations can be stored in instruction tightly-coupled memory 700.

As illustrated in FIG. 7A, instruction tightly-coupled memory 700 includes storage area 710 and storage area 720. Storage area 710 can be configured to and used in connection with storing audio processing instruction information. Storage area 720 can be configured to and used in connection with storing wake-up processing instruction information. I11 through I13 represent multiple pieces of instruction information stored in storage area 710. I21 through I23 represent multiple pieces of instruction information stored in storage area 720. According to various embodiments, a processor fetches instruction information via the access addresses E11 through E13 and E21 through E23. For example, to fetch instruction information corresponding to I11, the processor fetches information stored at address E11 of storage area 710.

FIG. 7B is a diagram of data tightly-coupled memory storing data information relating to audio processing and wake-up processing according to various embodiments of the present application.

Referring to FIG. 7B, data tightly-coupled memory 750 is provided. Data tightly-coupled memory 750 can be implemented in connection with processing unit 100 of FIG. 1, and/or processor core 200 of FIG. 2. Data tightly-coupled memory 750 can be implemented by method 500 of FIG. 5 (e.g., data tightly-coupled memory 750 can be accessed to fetch data such as data pertaining to an instruction to be performed). Data tightly-coupled memory 750 can be implemented in connection with data information from instruction tightly-coupled memory 700 of FIG. 7A (e.g., in connection with obtaining information associated with an instruction that is to be executed at least in part by a processor or processing system). Data tightly-coupled memory 750 can be implemented by electronic device 800 of FIG. 8A, electronic device 820 of FIG. 8B, electronic device 840 of FIG. 8C, and/or electronic device 860 of FIG. 8D.

According to various embodiments, data tightly-coupled memory 750 includes the storage area 760 and storage area 770. Storage area 760 can be configured to and used in connection with storing audio processing data information. Storage area 770 can be configured to and used in connection with storing wake-up processing data information. D11 through D13 represent multiple pieces of data information stored in storage area 760. D21 through D23 represent multiple pieces of data information stored in storage area 770. According to various embodiments, a processor fetches data information via the access addresses E31 through E33 and E41 through E43. For example, to fetch instruction information corresponding to D21, the processor fetches information stored at address E41 of storage area 770.

According to related art, audio processing solely uses instruction tightly-coupled memory, and wake-up processing solely uses data tightly-coupled memory. For example, according to the related art, audio processing uses a single tightly-coupled memory for both corresponding instruction information and data information. As another example, according to the related art, wake-up processing uses a single tightly-coupled memory for both corresponding instruction information and data information. That is, according to the related art, audio processing instruction information and data information are placed in the instruction tightly-coupled memory, and wake-up processing instruction information and data information are placed in the data tightly-coupled memory. With instruction information and data information placed together, according to related art, the processor will contend over the bus when accessing data information and fetching instruction information. Specifically, according to related art, when a processor accesses instruction information of the wake-up algorithm (e.g., an add instruction), the operands for the instruction are in the data tightly-coupled memory, and the processor will also need to access the bus to fetch the operands. At this point, a pause needs to be inserted in the instruction pipeline to wait to fetch the operand. An access conflict between the data information and the instruction information thereupon arises. This conflict wastes processor cycles and reduces computing efficiency.

In contrast to the related art, according to various embodiments, the instruction information and data information for audio processing and wake-up processing are stored separately (e.g., the instruction information and data information are stored in separate tightly-coupled memories). Accordingly, in some embodiments, the operations of fetching instructions from the instruction tightly-coupled memory and fetching data from the data tightly-coupled memory can be performed in the same clock cycle. The execution efficiency of the processor is thereby increased for processing, including wake-up processing and audio processing. In some embodiments, the storage area 710 stores instruction information of all instructions relating to audio processing, and the storage area 720 stores instruction information of all instructions relating to wake-up processing. Further, the storage area 760 stores data information of all data relating to audio processing, and the storage area 770 stores data information of all data relating to wake-up processing. Such an implementation of storing all instruction information for a particular type of processing (e.g., wake-up processing) in a single storage area (e.g., storage area 720) and all data information for a particular type of processing (e.g., wake-up processing) in a single storage area (e.g., storage area 770) is possible if both the data tightly-coupled memory and the instruction tightly-coupled memory have sufficient capacities. Storing all instruction information for a particular type of processing in a single storage area of the instruction tightly-coupled memory and all data information for the particular type of processing in a single storage area of the data tightly-coupled memory can improve the processing efficiency for the particular type of processing.

In some embodiments, the storage area 710 stores instruction information of core instructions relating to audio processing, and the storage area 720 stores instruction information of core instructions relating to wake-up processing. As used herein, core instructions can be kernel instructions. Further, the storage area 760 stores data information of partial data relating to audio processing. In some embodiments, the partial data corresponds to data information of key data relating to audio processing. In some embodiments, the partial data corresponds to data information of the data required by kernel instructions. The storage area 770 stores data information of partial data relating to wake-up processing. The partial data can correspond to data information of key data relating to wake-up processing, or the partial data can correspond to data information of the data required by core instructions. The storage of partial data for a particular type of processing can be implemented in contexts (e.g., processing systems) in which the capacity of data tightly-coupled memory and instruction tightly-coupled memory is inadequate for the system needs or requirements for storing all the instruction information or all the data information for a particular type of processing in a single storage area.

According to various embodiments, capacity in the tightly-coupled memory can be allocated (e.g., reallocated) to improve the efficiency of processing. For example, to improve the efficiency of wake-up processing and audio processing of an existing technical scheme in which there is 128 kb instruction tightly-coupled memory and 64 kb data tightly-coupled memory, capacity of one or more tightly-coupled memories can be adjusted, and/or all (or as much as possible) the requisite instruction information for a type of processing is stored in the instruction tightly-coupled memory and the requisite data information for the type of processing is stored in the data tightly-coupled memory (e.g., as opposed to only a smaller fraction of such requisite instruction information or data information being stored in the corresponding tightly-coupled memories).

According to various embodiments, to improve processing efficiency, the capacity of one or more of the instruction tightly-coupled memory and the data tightly-coupled memory is adjusted. Using the foregoing example, the instruction tightly-coupled memory capacity is set to 128 kb, and the data tightly-coupled memory is set to 64 kb.

According to various embodiments, to improve processing efficiency, because audio processing generally has a relatively smaller number of audio processing instructions, the instruction information of all instructions relating to audio processing is stored in the instruction tightly-coupled memory, and the great majority of data information for such audio processing is placed in the data tightly-coupled memory. With respect to wake-up processing, because such processing is not frequently executed, the instruction information of core instructions for wake-up processing can be stored in the instruction tightly-coupled memory, while instruction information of secondary instructions for wake-up processing is stored in other memory outside the processor, and all data information is placed in other memory outside the processor (e.g., the data information is stored in an external memory rather than tightly-coupled memory).

On the basis of the adjusted technical scheme, the data tightly-coupled memory will generally have spare storage space which the DMA controller can use. Thus, while wake-up processing is fetching instructions, the DMA controller is moving data. Data moving occupies roughly 80% of the CPU cycle. According to various embodiments, the data moving and calculations are executed in parallel throughout most of the CPU cycle, and wake-up processing efficiency is thereby improved. In summary, the adjusted technical scheme according to various embodiments has the following advantages: first, because instruction tightly-coupled memory and data tightly-coupled memory use the same medium (e.g., are the same type of memory) and have the same price, the adjustments will not lead to increased hardware costs. Second, audio processing instructions and wake-up processing instructions and data are stored separately, which solves the problem of conflicting claims on the bus. Third, data tightly-coupled memory is adjusted towards greater space, which allows more data to be put into the processor and makes moving data easier for the DMA controller.

Accordingly, system execution efficiency is increased. In some embodiments, the audio processing and wake-up processing referred to above correspond to compiled, executable code. During the chip manufacturing process, the executable code segments and data for the audio processing and wake-up can be burned into the flash memory of the processing system. After the system is powered on, the first step is to boot up the loader. The loader uses locations specified in link files to store instruction information and data information in flash memory into specified locations in the corresponding tightly-coupled memory (e.g., in the instruction tightly-coupled memory and the data tightly-coupled memory). The system then begins to run the instructions. In addition, there are some apps (e.g., including source code and executable code) stored on the hard drive. After user activation, the executable code is loaded into memory and then loaded into the processor. Processing units and/or processing systems according to various embodiments are applied to various electronic devices. The various electronic devices can include, but are not limited to, smart phones, smart speakers, smart television sets, set-top boxes, players, firewalls, routers, notebook computers, tablet computers, PDAs, and other composite units or terminals that combine these functions. These devices, units, and terminals may or may not be portable.

FIGS. 8A through 8D are diagrams of processing units implemented in an electronic device according to various embodiments of the present application.

Referring to FIGS. 8A through 8D, smart phone 800, smart speaker 820, television 840, and set-top box 860 are provided. Smart phone 800, smart speaker 820, television 840, and set-top box 860 can implement processing unit 100 of FIG. 1 and processor core 200 of FIG. 2. Smart phone 800, smart speaker 820, television 840, and set-top box 860 can implement processing system 300 of FIG. 3, processing system 400 of FIG. 4A, processing system 450 of FIG. 4B, and/or method 500 of FIG. 5. Smart phone 800, smart speaker 820, television 840, and set-top box 860 can include processing systems that can execute one or more instructions based at least in part on instruction pipeline 600 of FIG. 6. Smart phone 800, smart speaker 820, television 840, and set-top box 860 can include processing systems that can execute one or more instructions based at least in part on instruction information from instruction tightly-coupled memory 700 of FIG. 7A, and/or data information from data tightly-coupled memory 750 of FIG. 7B.

According to various embodiments, a smartphone 800 is provided. Various embodiments can be implemented in a control module 801 of smart phone 800. Smart phone 800 can include control module 801, memory 802, main memory 803, power source 804, WLAN interface 805, microphone 806, audio output device 807 (e.g., a speaker and/or an output jack), a display 808, a user input device 809 (e.g., a keyboard and/or a touchscreen), an antenna 810, and a phone network interface 811. Control module 801 can receive input signals from the phone network interface 811, the WLAN interface 805, the microphone 806, and/or the user input device 809. Control module 801 can perform signal processing, including encoding, decoding, automatic substitution, and/or formatting, to generate output signals. The output signals can be used in communication with one or more of the following: memory 802, main memory 803, the WLAN interface 805, the audio output device 807, and the phone network interface 811. Main memory 803 may include random access memory (RAM) and/or non-volatile memory, e.g., flash memory, phase change memory, or multi-state memory. Each of these memory units has more than two states. Memory 802 may include an optical storage drive, such as a DVD drive, and/or a hard drive (HDD). The power source 804 provides power to the smart phone 800.

Control module 801 can implement processing unit 100 of FIG. 1, processor core 200 of FIG. 2, and corresponds to processor core 110 of FIG. 1. Control module 801 can be implemented in processing system 300 of FIG. 3, processing system 400 of FIG. 4A, processing system 450 of FIG. 4B, and/or method 500 of FIG. 5.

According to various embodiments, a smart speaker 820 is provided. Various embodiments can be implemented in speaker controller 821 (e.g., player control module) of smart speaker 820. Smart speaker 820 can include speaker controller 821, memory 822, main memory 823, power source 824, audio output device 826, microphone 827, user input device 828, and external interface 830. The speaker controller 821 can receive input signals from the external interface 830. The external interface 830 may include a USB, infrared, and/or Ethernet. The input signals can include audio and/or video and can conform to an MP3 format. Various other audio/video formats can be implemented. In addition, the speaker controller 821 can receive input from the user input device 828, (e.g., a keyboard, a touchpad, stylus, or a single button). The speaker controller 821 can generate output signals, and perform input signal processing. Perming input signal processing can include performing one or more of including encoding, data, encoding, data decoding, automatic filtering, and/or formatting.

The speaker controller 821 can output audio signals to the audio output device 826 and output video signals to the display 827. The audio output device 826 may include a speaker and/or an output jack. The audio output device 826 can also include an input device such as a microphone. The power source 824 provides power to the components of the smart speaker 820. Main memory 823 can include random access memory (RAM) and/or non-volatile memory (e.g., flash memory, phase change memory, multi-state memory, etc.). Each of the various memory units can have more than two states. Memory 822 can include an optical storage drive, such as a DVD drive, and/or a hard drive (HDD).

Speaker controller 821 can implement processing unit 100 of FIG. 1 and processor core 200 of FIG. 2, and corresponds to processor core 110 of FIG. 1. Speaker controller 821 can be implemented in processing system 300 of FIG. 3, processing system 400 of FIG. 4A, processing system 450 of FIG. 4B, and/or method 500 of FIG. 5.

According to various embodiments, a television 840 is provided. Television 840 can be a smart television, a high-definition television (HDTV), or both. Various embodiments can be implemented in a control module 841 of television 840. Control module 841 can be an HDTV control module. Television 840 can include control module 841, memory 842, main memory 843, a power source 844, a WLAN interface 845, a display 846, an associated antenna 847, and an external interface 848. Television 840 can receive input signals from WLAN interface 845 and/or external interface 848. External interface 848 transmits and receives information via cable, broadband Internet, and/or satellite. Control module 841 can perform one or more of input signal processing, including encoding, decoding, filtering, and/or formatting, and generate output signals. The output signals can be transmitted to one or more of the following: memory 842, main memory 843, WLAN interface 845, display 846, and external interface 848. Main memory 843 may include random access memory (RAM) and/or non-volatile memory (e.g., flash memory, phase change memory, multi-state memory, etc.). Each of the various types of memory units can have more than two states. Memory 842 may include an optical storage drive, such as a DVD drive, and/or a hard disk (HDD). The power source 844 provides power to the components of the high-definition television 840.

Control module 841 can implement processing unit 100 of FIG. 1, processor core 200 of FIG. 2, and corresponds to processor core 110 of FIG. 1. Control module 841 can be implemented in processing system 300 of FIG. 3, processing system 400 of FIG. 4A, processing system 450 of FIG. 4B, and/or method 500 of FIG. 5.

According to various embodiments, a set-top box 860 is provided. Various embodiments can be implemented in set-top box control module 861 of set-top box 860. Set-top box 860 includes set-top box control module 861, display 866, power source 864, main memory 863, memory 862, WLAN interface 865, and antenna 867. Set-top box control module 861 can receive input signals from the WLAN interface 865 and external interface 868. External interface 868 can transmit and receive information via cable, broadband Internet, satellite, or the like. Set-top box control module 861 can perform one or more of signal processing, including encoding, decoding, decolorizing, filtering, and/or formatting, and can generate output signals. The output signals can include standard and/or high-definition audio and/or video signals. The output signals can be used in communication with the WLAN interface 865 and/or the display 866. The display 866 may include a television, an equalizer, and/or a monitor.

The power source 864 provides power to the components of set-top box 860. Main memory 863 can include random access memory (RAM) and/or non-volatile memory (e.g., flash memory, phase change memory, multi-state memory, etc.). Each of the memory units can have more than two states. Memory 862 may include an optical storage drive, such as a DVD drive, and/or a hard drive (HDD).

Set-top box control module 861 can implement processing unit 100 of FIG. 1, processor core 200 of FIG. 2, and corresponds to processor core 110 of FIG. 1. Set-top box control module 861 can be implemented in processing system 300 of FIG. 3, processing system 400 of FIG. 4A, processing system 450 of FIG. 4B, and/or method 500 of FIG. 5.

Various embodiments have a processing unit or processing system with a certain amount of processing capability (e.g., audio processing, wake-up processing, etc.) applicable to any system architecture and capable of taking the form of smart phones, smart speakers, television sets, set-top boxes, players, firewalls, routers, notebook computers, tablet computers, PDAs, Internet of Things (IoT) products, and other composite terminals that combine these functions. However, the economic values that processing units or processing systems implemented on the basis of different system architectures are capable of obtaining may vary.

For example, in the case of computer systems which already tend to be mature and stable, any hardware change (e.g., the addition of tightly-coupled memory) or a change in instruction and data tightly-coupled memory not only will affect those components themselves, but also may affect other hardware and software. Therefore, it becomes necessary to subject computer software and hardware systems to various function tests and performance tests during the laboratory stage. Such testing leads to a greater cost burden, but can ensure a major improvement in the overall performance and economic value of the computer system. The situation is different for a system-on-a-chip. Special-purpose SoCs generally have narrow function requirements, but the cost requirements are strict. System performance must be improved as much as possible under strict cost control conditions. The adjustments to the respective sizes of instruction tightly-coupled memory and data tightly-coupled memory and to the storage locations of instructions and data in the present invention can raise the overall efficiency of an SoC and lower energy consumption without the need for additional hardware. For example, after adjustments are made to the respective sizes of instruction tightly-coupled memory and data tightly-coupled memory and to the storage locations of instructions and data in an SoC that is for audio processing and wake-up processing, both the decrease in overall efficiency and the increase in energy consumption will be around 10%. Such a solution could be attractive to any cost-sensitive manufacturer. In particular, with the arrival of the Internet of Things age, high-quality, low-priced products are required at every node. Examples include face scanners, fingerprint readers, remote control devices, and home devices. Manufacturers that pursue efficiencies in product design and cost control are more likely to expand market share and obtain economic returns.

Various embodiments implement the aforementioned processing units, processing systems, or electronic devices with hardware, special-purpose electronic circuits, software, logic, or any combination thereof. To give an example, some aspects may be realized in hardware, while other aspects are realized in firmware or software executable by a controller, microprocessor, or other computing device, although various embodiments are not limited to these. Although various embodiments can be explained and described in the form of block charts or flowcharts or by other graphic representations, it is clear that these blocks, apparatuses, systems, techniques, or methods described in the text can be realized through the following non-restrictive examples: hardware, software, firmware, special-purpose circuits or logic, general-purpose hardware or controllers, other computing devices, or combinations thereof. One may implement circuit designs of the present invention in each component, such as an integrated circuit module, if it is relevant.

The above are merely preferred embodiments of the present invention and are not for the purpose of restricting the present invention. For a person skilled in the art, there may be various modifications and variations of the present invention. Any modification, equivalent substitution, or improvement made in the spirit and principles of the present invention shall be included within the protective scope of the present invention.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A processing unit, comprising:
an instruction tightly-coupled memory that is configured to store instruction information and not data information;
a data tightly-coupled memory that is configured to store data information and not instruction information; and
a processor core, the processor core being configured to execute one or more instructions, wherein in connection with executing the one or more instructions, the processor core reads instruction information from the instruction tightly-coupled memory, and reads data information from the data tightly-coupled memory.

2. The processing unit of claim 1, wherein the instruction tightly-coupled memory stores only the instruction information, and the data tightly-coupled memory stores only the data information.

3. The processing unit of claim 2, wherein the instruction information indicates one or more operations to be executed, and the data information indicates one or more operands corresponding to the one or more operations indicated by the instruction information.

4. The processing unit of claim 1, wherein a capacity of the instruction tightly-coupled memory is less than a capacity of the data tightly-coupled memory.

5. The processing unit of claim 4, wherein the capacity of the instruction tightly-coupled memory is 64 kb, and the capacity of the data tightly-coupled memory is 128 kb.

6. The processing unit of claim 1, wherein:
the instruction tightly-coupled memory stores instruction information of all instructions relating to audio processing, and the data tightly-coupled memory stores data information of all data relating to the audio processing; and/or
the instruction tightly-coupled memory stores instruction information of all instructions relating to wake-up processing and the data tightly-coupled memory stores data information of all data relating to the wake-up processing.

7. The processing unit of claim 1, wherein:
the instruction tightly-coupled memory stores instruction information of core instructions relating to audio processing, the said data tightly-coupled memory stores data information of data required by the core instructions relating to the audio processing; and/or
the instruction tightly-coupled memory stores instruction information of core instructions relating to wake-up processing, and the data tightly-coupled memory stores data information of data required by the core instructions relating to the wake-up processing.

8. The processing unit of claim 1, wherein:
the instruction tightly-coupled memory stores instruction information of all instructions relating to audio processing;
the data tightly-coupled memory stores data information of at least a portion of data relating to the audio processing;
the instruction tightly-coupled memory stores instruction information of core instructions relating to wake-up processing; and
the said data tightly-coupled memory does not store any data information relating to the wake-up processing.

9. The processing unit of claim 1, wherein:
the processor core executes one or more operations of:
fetching instruction information pertaining to the one or more instructions from the instruction tightly-coupled memory; and
reading data information pertaining to the one or more instructions from the data tightly-coupled memory; and
the fetching the instruction information and the reading the data information is executed in a same clock cycle.

10. The processing unit of claim 1, wherein the processing unit comprises a plurality of the data tightly-coupled memory.

11. The processing unit of claim 1, wherein: the processor core, via one or more respective data channels, reads instruction information pertaining to the one or more instructions from the instruction tightly-coupled memory, and reads data information pertaining to the one or more instructions from the data tightly-coupled memory.

12. The processing unit of claim 1, wherein:
the instruction tightly-coupled memory is configured to store only instruction information; and
the data tightly-coupled memory is configured to store only data information.

13. A processor, comprising:
a system bus interface; and
a processing unit, the processing unit comprising:
an instruction tightly-coupled memory that is configured to store instruction information and not data information;
a data tightly-coupled memory, that is configured to store data information and not instruction information; and
a processor core, the processor core being configured to execute one or more instructions, wherein in connection with executing the one or more instructions, the processor core reads instruction information from the instruction tightly-coupled memory, and reads data information from the data tightly-coupled memory;
wherein the processor is configured to communicate with one or more peripheral devices via the system bus interface.

14. The processor of claim 13, further comprising:
a high-speed cache;
wherein the processor obtains instruction information pertaining to the one or more instructions and data information pertaining to the one or more instructions via the high-speed cache.

15. The processor of claim 13, further comprising:
a direct memory access (DMA) controller;
wherein the instruction tightly-coupled memory obtains instruction information pertaining to the one or more instructions via the DMA controller, and/or the data tightly-coupled memory obtains data information pertaining to the one or more instructions via the DMA controller.

16. A processing system, comprising:
the processor of claim 13; and
an external memory.

17. The processing system of claim 16, wherein the processing system is a system-on-a-chip.

18. The processing system of claim 16, wherein:
the external memory stores at least a portion of instruction information pertaining to audio processing, and/or data information pertaining to the audio processing; and
the external memory stores at least a portion of instruction information pertaining to wake-up processing, and/or data information pertaining to the wake-up processing.

19. An electronic device, comprising:
the processor of claim 13;
a memory; and
one or more input/output devices.

20. A method, comprising:
reading instruction information from an instruction tightly-coupled memory;
reading data information from a data tightly-coupled memory; and
executing one or more operations corresponding to one or more instructions, the one or more instructions being executed based at least in part on the instruction information and the data information.

21. The method of claim 20, the instruction information indicates the one or more operations to be executed, and the data information indicates one or more operands corresponding to the one or more operations indicated by the instruction information.

22. The method of claim 20, further comprising:
the reading the instruction information from the instruction tightly-coupled memory and the reading the data information from the data tightly-coupled memory are performed within a same clock cycle.
